(19) United States
(12) Patent Application Publication
(10) Pub. No.: US 2026/0125623 A1
(43) Pub. Date: May 7, 2026

(54) PROCESS FOR MAKING A GRANULE OR POWDER CONTAINING A COMPLEXING AGENT

(71) Applicant: BASF SE, Ludwigshafen am Rhein (DE)

(72) Inventors: Astrid SCHMIDT, Ludwigshafen am Rhein (DE); Mattias ARNDT, Ludwigshafen am Rhein (DE); Michael Klemens MUELLER, Ludwigshafen am Rhein (DE); Nataliia SHYMANSKA, Ludwigshafen am Rhein (DE); Matthias VOGES, Ludwigshafen am Rhein (DE)

(21) Appl. No.: 18/686,236

(22) PCT Filed: Aug. 17, 2022
(86) PCT No.: PCT/EP2022/072987

§ 371 Date: Feb. 23, 2024

(30) Foreign Application Priority Data
Aug. 25, 2021 (EP) 21193045.8

(51) Int. Cl. C11D 11/00; C11D 3/10; C11D 3/33; C11D 17/00; C11D 17/06

(52) U.S. Cl. CPC C11D 11/0082; C11D 3/10; C11D 3/33; C11D 17/0039; C11D 17/06; C11D 2111/16; C11D 2111/18

(57) ABSTRACT

Process for making a granule comprising an alkali metal salt of an aminocarboxylate complexing agent (A), said process comprising the steps of
(a) providing an aqueous slurry or solution comprising an alkali metal salt of an aminocarboxylate complexing agent (A),
(b) treating said slurry or solution with carbon dioxide,
(c) removing most of the water by evaporation.

The present invention is directed towards a process for making a granule comprising an alkali metal salt of an aminocarboxylate complexing agent (A), said process comprising the steps of
(a) providing an aqueous slurry or solution comprising an alkali metal salt of an aminocarboxylate complexing agent (A),
(b) treating said slurry or solution with carbon dioxide,
(c) removing most of the water by evaporation.

Furthermore, the present invention is directed towards granules and powders of alkali metal salts of aminocarboxylate.

Chelating agents of the aminocarboxylate type such as methyl glycine diacetic acid (MGDA) and glutamic acid diacetic acid (GLDA) and their respective alkali metal salts are useful seques-trants for alkaline earth metal ions such as Ca²⁺ and Mg²⁺. A lot of aminocarboxylates show good biodegradability and are thus environmentally friendly. For that reason, they are recom-mended and used for various purposes such as laundry detergents and for automatic dishwashing (ADW) formulations, in particular for so-called phosphate-free laundry detergents and phos-phate-free ADW formulations.

Depending on the type of product—liquid home care and fabric care products versus solid home care and fabric care products—and the manufacturing process of solid home care and fabric care products care product manufacturers may either prefer to handle solutions of aminocarboxylates or solid aminocarboxylates, for example joint spray drying or solid mixing. Powders and granules of aminocarboxylates may be shipped economically due to their high active ingredient content that goes along with low water content. Therefore, convenient processes for providing granules are still of great commercial interest.

In WO 2009/103822, a process is disclosed in which slurries are granulated that have a certain solids content, with a gas inlet temperature of 120° C. or less. In WO 2012/168739, a process is disclosed wherein slurries of complexing agents are spray-dried under non-agglomerating conditions.

Both processes have their shortcomings. A low gas inlet temperature requires highly concentrated slurries or a huge amount of gas per unit of granule. A process using non-agglomerating conditions provides for powders only.

Many processes for making granules lead to undesired lumps, also referred to as overs. Such lumps may be milled down and re-introduced into the spray drying process, see WO 2017/220308, leading to good granules. However, the need to mill down a considerable share of lumps makes the process economically less favourable.

It was therefore an objective of the present invention to provide a process that allows to produce granules or powders of aminocarboxylate complexing agents with a low tendency of lump formation during the water removal. Additionally, it was an objective of the present invention to provide a process for making granules or powders of aminocarboxylate complexing agents with a low tendency to yellow and a good storage stability.

Accordingly, the process as defined at the outset has been defined, hereinafter also referred to as inventive process or as process according to the present invention. The inventive process comprises three mandatory steps, step (a), step (b), and step (c). They may in brief also be referred to as (a), (b) or (c), respectively. Steps (a), (b), and (c) are performed subsequently. Steps (a) to (c) are described in more detail below.

In step (a), an aqueous solution or slurry of an aminocarboxylate complexing agent (A) is provided, hereinafter also referred to as “salt (A)”. In this context, alkali metal salts are selected from lithium salts, sodium salts, potassium salts, rubidium salts, and cesium salts and combinations of at least two of the foregoing, with potassium salts being preferred and sodium salts being more preferred.

Examples of aminocarboxylate complexing agents are ethylenediamine tetraacetate (EDTA), iminodisuccinates, and diacetates of amino acids, especially alanine, glutamic acid, and aspar-tic acid, as well as combinations of at least two of the aforementioned.

Preferably, salt (A) is selected from methylglycine diacetic acid (MGDA).

Salts (A) may refer to fully neutralized aminocarboxylate complexing agents (A) and to partially neutralized aminocarboxylate complexing agents (A).

In one embodiment of the present invention, salt (A) is selected from compounds according to general formula (I)

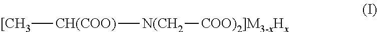

wherein
M is selected from alkali metal cations, same or different, preferably K or Na or combinations thereof, and even more preferably Na, and
x is in the range of from zero to 1.0, preferably zero to 0.30.

In any way, aqueous solutions or slurries of salt (A) may bear a cation other than alkali metal. It is thus possible that minor amounts, such as 0.01 to 5 mol-% of total MGDA, respectively, bear alkali earth metal cations such as Mg²⁺ or Ca²⁺, or an Fe²⁺ or Fe³⁺ cation.

As mentioned above, in step (a) an aqueous solution or slurry of salt (A) is provided. Aqueous solutions are defined herein as solutions with no solid particles detectable by visual inspection. Aqueous solutions may contain minor amounts of organic solvent that is or are miscible with water, for example ethanol, 1,2-propylenglycol, ethylene glycol, for example in a volume ratio water:organic solvent 5:1 to 100:1. Preferably, however, aqueous solutions provided in step (a) do not contain detectable amounts of organic solvent.

Slurries, on the other hand, contain solid particles of salt (A) that are detectable by visual inspection. Slurries are preferred. Aqueous slurries of salt (A) may be obtained by several ways:

Embodiment (a1): An aqueous solution of salt (A) is provided, for example concentrated or even supersaturated, and a powder of salt (A) is added, for example an amorphous powder obtained by spray drying.

Embodiment (a2): An aqueous concentrated or even supersaturated solution of salt (A) is provided, and upon storage, a slurry of a precipitate is formed.

Embodiment (a3): An aqueous solution of salt (A) is provided and further concentrated to form a slurried crystalline precipitate, for example as evaporation crystallization.

Embodiment (a4): An aqueous solution of salt (A) is provided, for example concentrated or even supersaturated, and crystals of salt (A) are added, for example obtained by crystallization or by adding crystals from a crystalline granule, with or without milling. The term “crystalline” includes materials that are crystalline to 65% or more, determined by X-ray diffraction.

Embodiment (a5): An aqueous slurry of salt (A) is provided, for example obtained according to (a2) or (a3) or (a4), and wet-milled, for example with 100 to 10,000 rpm. High values of 1,000 or more rpm may be achieved with an ultra-turrax.

In one version of embodiment (a4), the amount of added crystals is preferably 0.5 to 2% by weight of the total amount of salt (A) in the so obtained slurry. Optionally, from the slurry so obtained water, may be removed within one to seven hours, preferably in two to five hours and even more preferably in three to four hours, for example as evaporation crystallization.

Salts (A) are selected from the racemic mixtures, the D-isomers and the L-isomers, and from mixtures of the D- and L-isomers other than the racemic mixtures. Preferably, salt (A) is selected from the racemic mixture and from mixtures containing in the range of from 51 to 95 mole-% of the L-isomer, the balance being D-isomer. Particularly preferred are solutions of salt (A) being selected from the racemic mixture and mixtures of the enantiomers with predominantly the L-enantiomer with an ee value in the range of from 0.1% or from 0.5% to 35%. Other particularly preferred embodiments are racemic mixtures.

In one embodiment of the present invention, aqueous solutions or slurries of salt (A) may contain one or more impurities that may result from the synthesis of the respective salt (A). Such impurities may be selected from propionic acid, lactic acid, alanine, nitrilotriacetic acid (NTA) or the like and their respective alkali metal salts. Such impurities are usually present in minor amounts. “Minor amounts” in this context refer to a total of 0.1 to 5% by weight, referring to salt (A), preferably up to 2.5% by weight. In the context of the present invention, such minor amounts are neglected when determining the composition of granule made according to the inventive process.

In one embodiment of the present invention, aqueous solutions or slurries of salt (A) contain one or more inorganic salts, for example alkali metal hydroxide, alkali metal (bi)carbonate, alkali metal formate, or the like, for example in amounts of 0.5 to 10% by weight, referring to salt (A).

The concentration of salt (A) is in the range of from 25 to 70° by weight, preferably 30 to 65% by weight. The concentration may be determined by determination of the iron (III) binding capacity.

Solutions of salt (A) may be obtained through a double Singer reaction of an amino acid with hydrogen or alkali metal cyanide and formaldehyde, followed by saponification of the nitrile groups with alkali metal hydroxide, especially with NaOH. Solutions of salt (A) may be diluted with water or concentrated by evaporation of water to reach the concentrations as outlined above. Said solution as provided in step (a) usually has a pH value in the range of from 10 to 13.5, determined at 23° C. and at a concentration of 1% of salt (A) by weight.

In step (b), said slurry or solution of salt (A) is treated with carbon dioxide, for example by con-tacting said solution or slurry with carbon dioxide in the gas phase. Preferably, step (b) is performed by passing a stream of CO₂ through said solution or slurry. The stream of CO₂ that is passed through said slurry or solution of salt (A) may be diluted with air or an inert gas, e.g., nitrogen or a rare gas such as argon, a stream of pure carbon dioxide being preferred. Said stream of CO₂ may be introduced through one or more nozzles or through a glass frit.

In one embodiment of the present invention, step (b) is performed at a temperature in the range of from 5 to 95° C., preferably from 10 to 90° C., more preferably from 15 to 60° C. At higher tem-peratures, too much of CO₂ will pass through the solution or slurry without reacting.

In one embodiment of the present invention, step (b) is performed at a pressure in the range of from ambient pressure up to 10 bar, preferably at ambient pressure.

In one embodiment of the present invention, the pH value of the solution or slurry at the end of step (b) is in the range of from 9 to 11. In one embodiment, the pH value drops by 0.5 to 2.5 units in the course of step (b).

In one embodiment of the present invention, a gas mixture containing CO₂, for example a mixture from air and CO₂, or pure CO₂, is used as gas for introducing the solution or slurry of salt (A) into a drying apparatus, for example a spray tower or a spray granulator or an evaporation crystallizer.

By performing step (b), an acid-base reaction takes place, and in many embodiments a slight exothermic behavior may be observed. Without wishing to be bound to any particular theory, potential reactions are the neutralization of an excess of alkali metal hydroxide use for the manufacture of salt (A), or the formation of an equilibrium of MGDA-Na₃/MGDA-HNa₂, sodium car-bonate/sodium bicarbonate.

In step (c), most of the water is removed from the solution or slurry from step (b), preferably by an evaporation method. “Most of the water” shall mean that a residual moisture content of 0.1 to 20% by weight, referring to the manufactured powder or granule, remains, preferably 5 to 12% by weight. In embodiments that start off from a solution, about 51 to 75% by weight of the water present in the aqueous solution is removed in step (c).

In one embodiment of the present invention, step (c) is performed in a fluidized bed or in a spouted bed or in an essentially horizontal cylindrical drying apparatus containing a stirring element that rotates around an essentially horizontal axis.

Step (c) may be performed by introducing said aqueous slurry or aqueous solution into a spray tower or spray granulator. A spray granulator usually contains a fluidized bed, in the context of the present invention it is a fluidized bed of salt (A), or of inventive granule. Such fluidized bed of salt (A) is preferably in the form of chelating agent in crystalline form, for example at least 66% crystalline form, determined by X-Ray diffraction. In one embodiment of the present invention, the fluidized bed may have a temperature in the range of from 75 to 150° C., preferably 80 to 110° C. Spray towers usually do not contain any fluidized bed.

Spraying is performed through one or more nozzles per spray tower or spray granulator. Suitable nozzles are, for example, high-pressure rotary drum atomizers, rotary atomizers, three-fluid nozzles, single-fluid nozzles, three-fluid nozzles and two-fluid nozzles, single-fluid nozzles and two-fluid nozzles and three-fluid nozzles being preferred. The first fluid is the aqueous slurry or aqueous solution or emulsion, respectively, the second fluid is compressed gas, for example with a pressure of 1.1 to 7 bar. The compressed gas may have a temperature in the range of from at least 35° C. to 250° C., preferably 60 to 250° C., even more preferably 100 to 220° C.

In one embodiment the nozzle gas may have a temperature of ambient temperature, about 15-35° C.

In step (c), the pH adjusted aqueous slurry or aqueous solution of salt (A) is introduced in the form of droplets. In one embodiment of the present invention, the droplets formed during the spray-granulating or spray-drying have an average diameter in the range of from 10 to 500 μm, preferably from 20 to 180 μm, even more preferably from 30 to 100 μm.

In one embodiment of the present invention, the pressure in the spray tower or spray granulator in step (c) is normal pressure±100 mbar, preferably normal pressure±20 mbar, for example one mbar less than normal pressure.

In one embodiment of the present invention, especially in a process for making an inventive granule, the average residence time of salt (A) in step (c) is in the range of from 2 minutes to 4 hours, preferably from 30 minutes to 2 hours.

In another embodiment of the present invention, spray-granulation is performed by performing two or more consecutive spray-drying processes, for example in a cascade of at least two spray dryers, for example in a cascade of at least two consecutive spray towers or a combination of a spray tower and a spray chamber, said spray chamber containing a fluidized bed. In the first dryer, a spray-drying process is being performed in the way as follows.

Spray-drying may be preferred in a spray dryer, for example a spray chamber or a spray tower. An aqueous slurry or solution with a temperature preferably higher than ambient temperature, for example in the range of from 50 to 95° C. is introduced into the spray dryer through one or more spray nozzles into a hot gas inlet stream, for example nitrogen or air, the solution or slurry being converted into droplets and the water being vaporized. The hot gas inlet stream may have a temperature in the range of from 125 to 350° C. The second spray dryer is charged with a fluidized bed with solid from the first spray dryer and solution or slurry obtained according to the above step is sprayed onto or into the fluidized bed, together with a hot gas inlet stream. The hot gas inlet stream may have a temperature in the range of from 125 to 350° C., preferably 160 to 220° C.

In one embodiment of the present invention, a spray granulator is charged with a fluidized bed with solid (initial filling) and solution or slurry obtained according to the above step is sprayed onto or into the fluidized bed, together with a hot gas inlet stream. The hot gas inlet stream may have a temperature in the range of from 125 to 350° C., preferably 160 to 220° C.

In one embodiment of the present invention, the off-gas departing the spray tower or spray granulator, respectively, may have a temperature in the range of from 40 to 140° C., preferably 80 to 110° C. but in any way colder than the hot gas stream. Preferably, the temperature of the off-gas departing the drying vessel and the temperature of the solid product present in the drying vessel are identical.

In embodiments wherein an aged slurry is used, such aging may take in the range of from 2 hours to 24 hours at the temperature preferably higher than ambient temperature.

In step (c), further operations may be performed, for example separating off fines or lumps, milling down lumps, and/or returning fines and milled down lumps into the inventive process, for example by directly returning them into a spray granulator—or dissolving them in water and then spray-drying.

It is observed that the share of lumps formed in the course of step (c) when performing the inventive process is significantly lower than in comparative processes that lack step (b).

In embodiments wherein granules are desired, said lumps to be separated off are particles that have a minimum particle diameter of 1,000 μm, for example, 1,500 μm to 2 mm or even more.

In a preferred embodiment, lumps are particles that have a minimum particle diameter of 1,250 μm or more, even more preferably 900 μm to 2 mm.

In embodiments wherein powders are desired, said lumps or overs have a minimum particle diameter of 250 μm or more, for example 250 to 1,000 μm.

In one embodiment of the present invention, the amount of powder or granule, respectively, other than fines and overs is in the range of from 30 to 75% by weight, referring to total amount of material removed at the end of step (c). The amount of overs (lumps) is significantly reduced compared to the prior art.

In one embodiment of the present invention, the share of lumps is in the range of from 2 to 45% by weight of the total salt (A) withdrawn in step (e), preferably 3 to 40% by weight.

Granules and powders obtained by the inventive process show excellent low yellowing behavior, especially in the presence of peroxides such as sodium percarbonate.

A further aspect of the present invention relates to powders and to granules, hereinafter also referred to as inventive powders or inventive granules, respectively. Inventive granule or powder contain an alkali metal salt (A) of an aminocarboxylate complexing agent wherein said granule or powder contains in the range of from 0.1 to 10% by weight of alkali metal carbonate, preferably 0.5 to 8% and even more preferably 3.1 to 6% by weight, referring to said granule. Preferably, said alkali metal in salt (A) is the same kind—or the same combination—as in alkali metal carbonate.

In inventive granules and powders, a least of all 90% particles contain both alkali metal salt (A) of an aminocarboxylate complexing and alkali metal carbonate, preferably at least 95% and more preferably at least 99%.

In one embodiment of the present invention, alkali metal carbonate is homogeneously distribut-ed/uniformly dispersed within the particles of inventive granule. In one embodiment of the present invention, alkali metal carbonate is homogeneously distributed/uniformly dispersed within the particles of inventive powder.

In one embodiment of the present invention, said salt (A) is selected from compounds according to general formula (I a)

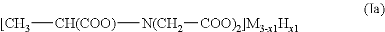

wherein M is selected from alkali metal cations, same or different, and
x1 is in the range of from zero to 1.0.

In one embodiment of the present invention, inventive granule has an average particle diameter d50 in the range of from 150 μm to 1.5 mm, preferably 250 μm to 1 mm. The particle diameter refers to the volume based particle diameter and may be determined, e.g., by sieving methods.

In one embodiment of the present invention, inventive powder has an average particle diameter d50 in the range of from 50 μm to 125 μm. The particle diameter refers to the volume based particle diameter and may be determined, e.g., by sieving methods.

In the context of the present invention, average particle diameter d50 may be used with or without brackets.

In one embodiment of the present invention, inventive powder and inventive granule additionally contains alkali metal sulfate or alkali metal citrate that is dispersed in salt (A) in the outer layer of or preferably all through the particles of the respective powder or granule. In addition, said powder or granule may contain separate crystals of alkali metal sulfate or alkali metal citrate. However, inventive powders and inventive granules do not contain a homogeneous coating of alkali metal sulfate or alkali metal citrate.

Inventive granules and inventive powders show excellent low yellowing behavior, especially in the presence of peroxides such as sodium percarbonate. They are therefore excellently suited for the manufacture and as components of solid cleaning agents such as automatic dishwashing compositions. In addition, their manufacture is favorable because during their manufacture by spray drying or spray granulation produces a lower share of undesired overs or lumps.

A further aspect of the present invention relates to solid cleaners, e.g., solid automatic dishwashing compositions containing at least one inventive powder or one inventive granule.

Another aspect of the present invention relates to the use of inventive granules, and another aspect of the present invention relates to methods of use inventive granules. The preferred use of inventive granules is for the manufacture of solid laundry detergent compositions and of solid detergent compositions for hard surface cleaning, especially of solid automatic dishwashing detergents. Solid laundry detergent compositions and solid detergent compositions for hard surface cleaning may contain some residual moisture, for example 0.1 to 10% by weight, but are otherwise solid mixtures in the form of, e.g., powders, granules or tablets. The residual moisture content may be determined, e.g., by drying under vacuum at 80° C. Another aspect of the present invention relates to solid laundry detergent compositions and to solid detergent compositions for hard surface cleaning.

In the context of the present invention, the term “detergent composition for cleaners” includes cleaners for home care and for industrial or institutional applications. The term “detergent composition for hard surface cleaners” includes compositions for dishwashing, especially hand dishwash and automatic dishwashing and ware-washing, and compositions for other hard surface cleaning such as, but not limited to compositions for bathroom cleaning, kitchen cleaning, floor cleaning, descaling of pipes, window cleaning, car cleaning including truck cleaning, furthermore, open plant cleaning, cleaning-in-place, metal cleaning, disinfectant cleaning, farm cleaning, high pressure cleaning, but not laundry detergent compositions.

In the context of the present invention and unless expressly stated otherwise, percentages in the context of ingredients of laundry detergent compositions are percentages by weight and refer to the total solids content of the respective laundry detergent composition. In the context of the present invention and unless expressly stated otherwise, percentages in the context of ingredients of detergent composition for hard surface cleaning are percentages by weight and refer to the total solids content of the detergent composition for hard surface cleaner.

In one embodiment of the present invention, solid laundry detergent compositions according to the present invention may contain in the range of from 1 to 30% by weight of inventive granule. Percentages refer to the total solids content of the respective laundry detergent composition.

In one embodiment of the present invention, inventive solid detergent compositions for hard surface cleaning may contain in the range of from 1 to 50% by weight of inventive granule, preferably 5 to 40% by weight and even more preferably 10 to 25% by weight. Percentages refer to the total solids content of the respective detergent composition for hard surface cleaning.

Particularly advantageous inventive solid detergent compositions for hard surface cleaning and inventive solid laundry detergent compositions, especially for home care, contain one or more complexing agent other than inventive granule. Inventive solid detergent compositions for hard surface cleaning and inventive solid laundry detergent compositions may contain one or more complexing agent (in the context of the present invention also referred to as sequestrant) other than an inventive granule. Examples are citrate, phosphonic acid derivatives, for example the disodium salt of hydroxyethane-1,1-diphosphonic acid (“HEDP”), and polymers with complexing groups like, for example, polyethylenimine in which 20 to 90 mole-% of the N-atoms bear at least one CH₂COO⁻ group, and their respective alkali metal salts, especially their sodium salts, for IDS-Na₄, and trisodium citrate, and phosphates such as STPP (sodium tripolyphosphate). Due to the fact that phosphates raise environmental concerns, it is preferred that advantageous detergent compositions for cleaners and advantageous laundry detergent compositions are free from phosphate. “Free from phosphate” should be understood in the context of the present invention, as meaning that the content of phosphate and polyphosphate is in sum in the range from 10 ppm to 0.2% by weight, determined by gravimetric analysis.

Preferred inventive solid detergent compositions for hard surface cleaning and preferred inventive solid laundry detergent compositions may contain one or more surfactant, preferably one or more non-ionic surfactant.

Preferred non-ionic surfactants are alkoxylated alcohols, di- and multiblock copolymers of ethylene oxide and propylene oxide and reaction products of sorbitan with ethylene oxide or propylene oxide, alkyl polyglycosides (APG), hydroxyalkyl mixed ethers and amine oxides.

Preferred examples of alkoxylated alcohols and alkoxylated fatty alcohols are, for example, compounds of the general formula (III)

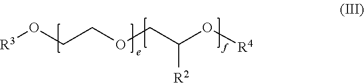

in which the variables are defined as follows:
R² is identical or different and selected from hydrogen and linear C₁-C₁₀-alkyl, preferably in each case identical and ethyl and particularly preferably hydrogen or methyl,
R³ is selected from C₈-C₂₂-alkyl, branched or linear, for example n-C₈H₁₇, n-C₁₀H₂₁, n-C₁₂H₂₅, n-C₁₄H₂₉, n-C₁₆H₃₃ or n-C₁₈H₃₇,
R⁴ is selected from C₁-C₁₀-alkyl, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl or isodecyl,

The variables e and f are in the range from zero to 300, where the sum of e and f is at least one, preferably in the range of from 3 to 50. Even more preferably, e is in the range from 1 to 100 and f is in the range from 0 to 30.

In one embodiment, compounds of the general formula (III) may be block copolymers or random copolymers, preference being given to block copolymers.

Other preferred examples of alkoxylated alcohols are, for example, compounds of the general formula (IV)

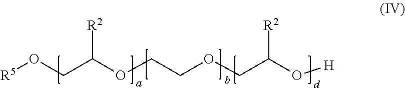

in which the variables are defined as follows:
R² is identical or different and selected from hydrogen and linear C₁-C₀-alkyl, preferably identical in each case and ethyl and particularly preferably hydrogen or methyl,
R⁵ is selected from C₆-C₂₀-alkyl, branched or linear, in particular n-C₈H₁₇, n-C₁₀H₂₁, n-C₁₂H₂₅, n-C₁₃H₂₇, n-C₁₅H₃₁, n-C₁₄H₂₉, n-C₁₆H₃₃, n-C₁₈H₃₇,
a is a number in the range from zero to 10, preferably from 1 to 6,
b is a number in the range from 1 to 80, preferably from 4 to 20,
d is a number in the range from zero to 50, preferably 4 to 25.

The sum a+b+d is preferably in the range of from 5 to 100, even more preferably in the range of from 9 to 50.

Preferred examples for hydroxyalkyl mixed ethers are compounds of the general formula (V)

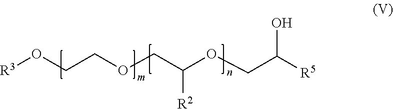

in which the variables are defined as follows:
R² is identical or different and selected from hydrogen and linear C₁-C₁₀-alkyl, preferably in each case identical and ethyl and particularly preferably hydrogen or methyl,
R³ is selected from C₈-C₂₂-alkyl, branched or linear, for example iso-C₁₁H₂₃, iso-C₁₃H₂₇, n-C₈H₁₇, n-C₁₀H₂₁, n-C₁₂H₂₅, n-C₁₄H₂₉, n-C₁₆H₃₃ or n-C₁₈H₃₇,
R⁵ is selected from C₆-C₂₀-alkyl, for example n-hexyl, isohexyl, sec-hexyl, n-heptyl, n-octyl, 2-ethylhexyl, n-nonyl, n-decyl, isodecyl, n-dodecyl, n-tetradecyl, n-hexadecyl, and n-octadecyl.

The variables m and n are in the range from zero to 300, where the sum of n and m is at least one, preferably in the range of from 5 to 50. Preferably, m is in the range from 1 to 100 and n is in the range from 0 to 30.

Compounds of the general formula (IV) and (V) may be block copolymers or random copolymers, preference being given to block copolymers.

Further suitable non-ionic surfactants are selected from di- and multiblock copolymers, com-posed of ethylene oxide and propylene oxide. Further suitable non-ionic surfactants are selected from ethoxylated or propoxylated sorbitan esters. Amine oxides or alkyl polyglycosides, especially linear C₄-C₁₆-alkyl polyglucosides and branched C₈-C₁₄-alkyl polyglycosides such as compounds of general average formula (VI) are likewise suitable.

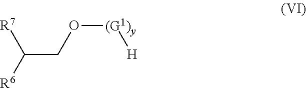

wherein:
R⁶ is C₁-C₄-alkyl, in particular ethyl, n-propyl or isopropyl,
R⁷ is —(CH₂)₂-R⁶,
G¹ is selected from monosaccharides with 4 to 6 carbon atoms, especially from glucose and xylose,
y in the range of from 1.1 to 4, y being an average number,

Further examples of non-ionic surfactants are compounds of general formula (VII) and (VIII)

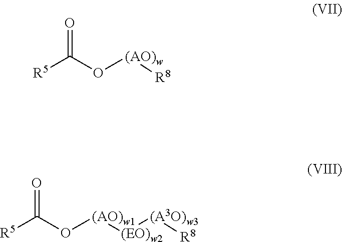

AO is selected from ethylene oxide, propylene oxide and butylene oxide,
EO is ethylene oxide, CH₂CH₂—O,
R^{a} selected from C₈-C₁₈-alkyl, branched or linear, and R⁵ is defined as above.

A³O is selected from propylene oxide and butylene oxide,
w is a number in the range of from 15 to 70, preferably 30 to 50,
w1 and w3 are numbers in the range of from 1 to 5, and
w2 is a number in the range of from 13 to 35.

An overview of suitable further non-ionic surfactants can be found in EP-A 0 851 023 and in DE-A 198 19 187.

Mixtures of two or more different non-ionic surfactants selected from the foregoing may also be present.

Other surfactants that may be present are selected from amphoteric (zwitterionic) surfactants and anionic surfactants and mixtures thereof.

Examples of amphoteric surfactants are those that bear a positive and a negative charge in the same molecule under use conditions. Preferred examples of amphoteric surfactants are so-called betaine-surfactants. Many examples of betaine-surfactants bear one quaternized nitrogen atom and one carboxylic acid group per molecule. A particularly preferred example of amphoteric surfactants is cocamidopropyl betaine (lauramidopropyl betaine).

Examples of amine oxide surfactants are compounds of the general formula (IX)

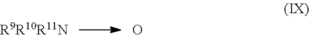

wherein R⁹, R¹⁰, and R¹¹ are selected independently from each other from aliphatic, cycloali-phatic or C₂-C₄-alkylene C₁₀-C₂₀-alkylamido moieties. Preferably, R⁹ is selected from C₈-C₂₀-alkyl or C₂-C₄-alkylene C₁₀-C₂₀-alkylamido and R¹⁰ and R¹¹ are both methyl.

A particularly preferred example is lauryl dimethyl aminoxide, sometimes also called lauramine oxide. A further particularly preferred example is cocamidylpropyl dimethylaminoxide, sometimes also called cocamidopropylamine oxide.

Examples of suitable anionic surfactants are alkali metal and ammonium salts of C₈-C₁₈-alkyl sulfates, of C₈-C₁₈-fatty alcohol polyether sulfates, of sulfuric acid half-esters of ethoxylated C₄-C₁₂-alkylphenols (ethoxylation: 1 to 50 mol of ethylene oxide/mol), C₁₂-C₁₈ sulfo fatty acid alkyl esters, for example of C₁₂-C₁₈ sulfo fatty acid methyl esters, furthermore of C₁₂-C₁₈-alkylsulfonic acids and of C₁₀-C₁₃-alkylarylsulfonic acids. Preference is given to the alkali metal salts of the aforementioned compounds, particularly preferably the sodium salts.

Further examples for suitable anionic surfactants are soaps, for example the sodium or potassium salts of stearic acid, oleic acid, palmitic acid, ether carboxylates, and alkylether phosphates.

Preferably, inventive laundry detergent compositions contain at least one anionic surfactant.

In one embodiment of the present invention, inventive solid laundry detergent compositions may contain 0.1 to 60% by weight of at least one surfactant, selected from anionic surfactants, amphoteric surfactants and amine oxide surfactants.

In one embodiment of the present invention, inventive solid detergent compositions for cleaners may contain 0.1 to 60% by weight of at least one surfactant, selected from anionic surfactants, amphoteric surfactants and amine oxide surfactants.

In a preferred embodiment, inventive solid detergent compositions for cleaners and especially those for automatic dishwashing do not contain any anionic surfactant.

Inventive solid detergent compositions for hard surface cleaning and inventive solid laundry detergent compositions may contain at least one bleaching agent, also referred to as bleach. Bleaching agents may be selected from chlorine bleach and peroxide bleach, and peroxide bleach may be selected from inorganic peroxide bleach and organic peroxide bleach. Preferred are inorganic peroxide bleaches, selected from alkali metal percarbonate, alkali metal perborate and alkali metal persulfate.

Examples of organic peroxide bleaches are organic percarboxylic acids, especially organic percarboxylic acids.

In inventive solid detergent compositions for hard surface cleaning and in inventive solid laundry detergent compositions, alkali metal percarbonates, especially sodium percarbonates, are preferably used in coated form. Such coatings may be of organic or inorganic nature. Examples are glycerol, sodium sulfate, silicate, sodium carbonate, and combinations of at least two of the foregoing, for example combinations of sodium carbonate and sodium sulfate.

Suitable chlorine-containing bleaches are, for example, 1,3-dichloro-5,5-dimethylhydantoin, N-chlorosulfamide, chloramine T, chloramine B, sodium hypochlorite, calcium hypochlorite, magnesium hypochlorite, potassium hypochlorite, potassium dichloroisocyanurate and sodium dichloroisocyanurate.

Inventive solid detergent compositions for hard surface cleaning and inventive solid laundry detergent compositions may comprise, for example, in the range from 3 to 10% by weight of chlo-rine-containing bleach.

Inventive solid detergent compositions for hard surface cleaning and inventive solid laundry detergent compositions may comprise one or more bleach catalysts. Bleach catalysts can be selected from bleach-boosting transition metal salts or transition metal complexes such as, for example, manganese-, iron-, cobalt-, ruthenium- or molybdenum-salen complexes or carbonyl complexes. Manganese, iron, cobalt, ruthenium, molybdenum, titanium, vanadium and copper complexes with nitrogen-containing tripod ligands and also cobalt-, iron-, copper- and rutheni-um-amine complexes can also be used as bleach catalysts.

Inventive solid detergent compositions for hard surface cleaning and inventive solid laundry detergent compositions may comprise one or more bleach activators, for example N-methylmorpholinium-acetonitrile salts (“MMA salts”), trimethylammonium acetonitrile salts, N-acylimides such as, for example, N-nonanoylsuccinimide, 1,5-diacetyl-2,2-dioxohexahydro-1,3,5-triazine (“DADHT”) or nitrile quats (trimethylammonium acetonitrile salts). Further examples of suitable bleach activators are tetraacetylethylenediamine (TAED) and tetraacetylhexylenediamine.

Inventive solid detergent compositions for hard surface cleaning and inventive solid laundry detergent compositions may comprise one or more corrosion inhibitors. In the present case, this is to be understood as including those compounds which inhibit the corrosion of metal. Examples of suitable corrosion inhibitors are triazoles, in particular benzotriazoles, bisbenzotriazoles, ami-notriazoles, alkylaminotriazoles, also phenol derivatives such as, for example, hydroquinone, pyrocatechol, hydroxyhydroquinone, gallic acid, phloroglucinol or pyrogallol.

In one embodiment of the present invention, inventive solid detergent compositions for hard surface cleaning and inventive solid laundry detergent compositions comprise in total in the range from 0.1 to 1.5% by weight of corrosion inhibitor.

Inventive solid detergent compositions for hard surface cleaning and inventive solid laundry detergent compositions may comprise one or more builders, selected from organic and inorganic builders. Examples of suitable inorganic builders are sodium sulfate or sodium carbonate or silicates, in particular sodium disilicate and sodium metasilicate, zeolites, sheet silicates, in particular those of the formula α-Na₂Si₂O₅, δ-Na₂Si₂O₅, and 6-Na₂Si₂O₅, also fatty acid sulfonates, α-hydroxypropionic acid, alkali metal malonates, fatty acid sulfonates, alkyl and alkenyl disuc-cinates, tartaric acid diacetate, tartaric acid monoacetate, oxidized starch, and polymeric builders, for example polycarboxylates and polyaspartic acid.

Examples of organic builders are especially polymers and copolymers. In one embodiment of the present invention, organic builders are selected from polycarboxylates, for example alkali metal salts of (meth)acrylic acid homopolymers or (meth)acrylic acid copolymers.

Suitable comonomers are monoethylenically unsaturated dicarboxylic acids such as maleic acid, fumaric acid, maleic anhydride, itaconic acid and citraconic acid. A suitable polymer is in particular polyacrylic acid, which preferably has an average molecular weight M, in the range from 2000 to 40 000 g/mol, preferably 2000 to 10 000 g/mol, in particular 3000 to 8000 g/mol. Also of suitability are copolymeric polycarboxylates, in particular those of acrylic acid with methacrylic acid and of acrylic acid or methacrylic acid with maleic acid and/or fumaric acid, and in the same range of molecular weight.

It is also possible to use copolymers of at least one monomer from the group consisting of monoethylenically unsaturated C₃-C₁₀-mono- or C₄-C₁₀-dicarboxylic acids or anhydrides thereof, such as maleic acid, maleic anhydride, acrylic acid, methacrylic acid, fumaric acid, itaconic acid and citraconic acid, with at least one hydrophilic or hydrophobic monomer as listed below.

Suitable hydrophobic monomers are, for example, isobutene, diisobutene, butene, pentene, hexene and styrene, olefins with 10 or more carbon atoms or mixtures thereof, such as, for example, 1-decene, 1-dodecene, 1-tetradecene, 1-hexadecene, 1-octadecene, 1-eicosene, 1-docosene, 1-tetracosene and 1-hexacosene, C₂₂-α-olefin, a mixture of C₂₀-C₂₄-α-olefins and polyisobutene having on average 12 to 100 carbon atoms per molecule.

Suitable hydrophilic monomers are monomers with sulfonate or phosphonate groups, and also non-ionic monomers with hydroxyl function or alkylene oxide groups. By way of example, men-tion may be made of: allyl alcohol, isoprenol, methoxypolyethylene glycol (meth)acrylate, meth-oxypolypropylene glycol (meth)acrylate, methoxypolybutylene glycol (meth)acrylate, methoxy-poly(propylene oxide-co-ethylene oxide) (meth)acrylate, ethoxypolyethylene glycol (meth)acrylate, ethoxypolypropylene glycol (meth)acrylate, ethoxypolybutylene glycol (meth)acrylate and ethoxypoly(propylene oxide-co-ethylene oxide) (meth)acrylate. Polyalkylene glycols here may comprise 3 to 50, in particular 5 to 40 and especially 10 to 30 alkylene oxide units per molecule.

Particularly preferred sulfonic-acid-group-containing monomers here are 1-acrylamido-1-propanesulfonic acid, 2-acrylamido-2-propanesulfonic acid, 2-acrylamido-2-methylpropanesulfonic acid, 2-methacrylamido-2-methylpropanesulfonic acid, 3-methacrylamido-2-hydroxypropanesulfonic acid, allylsulfonic acid, methallylsulfonic acid, a1-lyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 2-sulfoethyl methacrylate, 3-sulfopropyl methacrylate, sulfomethacrylamide, sulfomethylmethacrylamide, and salts of said acids, such as sodium, potassium or ammonium salts thereof.

Particularly preferred phosphonate-group-containing monomers are vinylphosphonic acid and its salts.

A further example of builders is carboxymethyl inulin.

Moreover, amphoteric polymers can also be used as builders.

Inventive solid detergent compositions for hard surface cleaning and inventive solid laundry detergent compositions may comprise, for example, in the range from in total 10 to 70% by weight, preferably up to 50% by weight, of builder. In the context of the present invention, (A1) and (A2) are not counted as builder.

In one embodiment of the present invention, inventive solid detergent compositions for hard surface cleaning and inventive solid laundry detergent compositions may comprise one or more cobuilders.

Inventive solid detergent compositions for hard surface cleaning and inventive solid laundry detergent compositions may comprise one or more antifoams, selected for example from silicone oils and paraffin oils.

In one embodiment of the present invention, inventive solid detergent compositions for hard surface cleaning and inventive solid laundry detergent compositions comprise in total in the range from 0.05 to 0.5% by weight of antifoam.

Inventive solid detergent compositions for hard surface cleaning and inventive solid laundry detergent compositions may comprise one or more enzymes. Examples of enzymes are lipases, hydrolases, amylases, proteases, cellulases, esterases, pectinases, lactases and peroxidases.

In one embodiment of the present invention, inventive solid detergent compositions for hard surface cleaning and inventive solid laundry detergent compositions may comprise, for example, up to 5% by weight of enzyme, preference being given to 0.1 to 3% by weight. Said enzyme may be stabilized, for example with the sodium salt of at least one C₁-C₃-carboxylic acid or C₄-C₁₀-dicarboxylic acid. Preferred are formates, acetates, adipates, and succinates.

In one embodiment of the present invention, inventive solid detergent compositions for hard surface cleaning and inventive solid laundry detergent compositions comprise at least one zinc salt. Zinc salts can be selected from water-soluble and water-insoluble zinc salts. In this connection, within the context of the present invention, water-insoluble is used to refer to those zinc salts which, in distilled water at 25° C., have a solubility of 0.1 g/I or less. Zinc salts which have a higher solubility in water are accordingly referred to within the context of the present invention as water-soluble zinc salts.

In one embodiment of the present invention, zinc salt is selected from zinc benzoate, zinc glu-conate, zinc lactate, zinc formate, ZnCl₂, ZnSO₄, zinc acetate, zinc citrate, Zn(NO₃)₂, Zn(CH₃SO₃)₂ and zinc gallate, preferably ZnCl₂, ZnSO₄, zinc acetate, zinc citrate, Zn(NO₃)₂, Zn(CH₃SO₃)₂ and zinc gallate.

In another embodiment of the present invention, zinc salt is selected from ZnO, ZnO·aq, Zn(OH)₂ and ZnCO₃. Preference is given to ZnO·aq.

In one embodiment of the present invention, zinc salt is selected from zinc oxides with an average particle diameter (weight-average) in the range from 10 nm to 100 μm.

The cation in zinc salt can be present in complexed form, for example complexed with ammonia ligands or water ligands, and in particular be present in hydrated form. To simplify the notation, within the context of the present invention, ligands are generally omitted if they are water ligands.

Depending on how the pH of mixture according to the invention is adjusted, zinc salt can change. Thus, it is for example possible to use zinc acetate or ZnCl₂ for preparing formulation according to the invention, but this converts at a pH of 8 or 9 in an aqueous environment to ZnO, Zn(OH)₂ or ZnO·aq, which can be present in non-complexed or in complexed form.

Zinc salt may be present in those detergent compositions for cleaners according to the invention which are solid at room temperature are preferably present in the form of particles which have for example an average diameter (number-average) in the range from 10 nm to 100 μm, preferably 100 nm to 5 μm, determined for example by X-ray scattering.

Zinc salt may be present in those detergent compositions for home which are liquid at room temperature in dissolved or in solid or in colloidal form.

In one embodiment of the present invention, detergent compositions for cleaners and laundry detergent compositions comprise in total in the range from 0.05 to 0.4% by weight of zinc salt, based in each case on the solids content of the composition in question.

Here, the fraction of zinc salt is given as zinc or zinc ions. From this, it is possible to calculate the counterion fraction.

In one embodiment of the present invention, inventive solid detergent compositions for hard surface cleaning and inventive solid laundry detergent compositions are free from heavy metals apart from zinc compounds. Within the context of the present, this may be understood as meaning that detergent compositions for cleaners and laundry detergent compositions according to the invention are free from those heavy metal compounds which do not act as bleach catalysts, in particular of compounds of iron and of bismuth. Within the context of the present invention, “free from” in connection with heavy metal compounds is to be understood as meaning that the content of heavy metal compounds which do not act as bleach catalysts is in sum in the range from 0 to 100 ppm, determined by the leach method and based on the solids content. Preferably, formulation according to the invention has, apart from zinc, a heavy metal content below 0.05 ppm, based on the solids content of the formulation in question. The fraction of zinc is thus not included.

Within the context of the present invention, “heavy metals” are defined to be any metal with a specific density of at least 6 g/cm³ with the exception of zinc. In particular, the heavy metals are metals such as bismuth, iron, copper, lead, tin, nickel, cadmium and chromium.

Preferably, inventive solid detergent compositions for hard surface cleaning and inventive solid laundry detergent compositions comprise no measurable fractions of bismuth compounds, i.e. for example less than 1 ppm.

In one embodiment of the present invention, inventive solid detergent compositions for hard surface cleaning and inventive solid laundry detergent compositions comprise one or more further ingredient such as fragrances, dyestuffs, organic solvents, buffers, disintegrants for tablets (“tabs”), and/or acids such as methylsulfonic acid.

Preferred example detergent compositions for automatic dishwashing may be selected according to table 1.

TABLE 1
Example detergent compositions for automatic dishwashing

| All amounts in g/sample | ADW.1 | ADW.2 | ADW.3 |
|---|---|---|---|
| Granule according to | 30 | 22.5 | 15 |
| example II.1 | | | |
| Protease | 2.5 | 2.5 | 2.5 |
| Amylase | 1 | 1 | 1 |
| n-C₁₈H₃₇-O(CH₂CH₂O)₉H | 5 | 5 | 5 |
| Polyacrylic acid M_{w} 4000 g/mol as | 10 | 10 | 10 |
| sodium salt, completely neutralized | | | |
| Sodium percarbonate | 10.5 | 10.5 | 10.5 |
| TAED | 4 | 4 | 4 |
| Na₂Si₂O₅ | 2 | 2 | 2 |
| Na₂CO₃ | 19.5 | 19.5 | 19.5 |
| Sodium citrate dihydrate | 15 | 22.5 | 30 |
| HEDP | 0.5 | 0.5 | 0.5 |
| ethoxylated polyethylenimine, 20 | optionally: | optionally: | optionally: |
| EO/NH group, Mₙ: 30,000 g/mol | 0.1 | 0.1 | 0.1 |

Laundry detergent compositions according to the invention are useful for laundering any type of laundry, and any type of fibres. Fibres can be of natural or synthetic origin, or they can be mixtures of natural of natural and synthetic fibres. Examples of fibers of natural origin are cotton and wool. Examples for fibers of synthetic origin are polyurethane fibers such as Spandexe or Lycra®, polyester fibers, or polyamide fibers. Fibers may be single fibers or parts of textiles such as knitwear, wovens, or nonwovens.

Another aspect of the present invention is a process for making tablets for automatic dishwashing from a powder or granule, wherein said granule or powder is selected from inventive granules and inventive powders, respectively. Said process is hereinafter also referred to as pelletizing process according to the invention.

Inventive tablets are preferably made with the help of a machine, for example a tablet press.

The pelletizing process according to the invention can be carried out by mixing inventive granule or powder with at least one non-ionic surfactant and optionally one or more further sub-stance and then compressing the mixture to give tablets. Examples of suitable non-ionic surfactants and further substances such as builders, enzymes are listed above. Particularly preferred examples of non-ionic surfactants are hydroxy mixed ethers, for example hydroxy mixed ethers of the general formula (V).

The invention is further illustrated by working examples.

Starting materials:
(A.1): trisodium salt of methylglycine diacetic acid (MGDA-Na₃) as 40% by weight aqueous solution, also referred to as C-SL.4.
General: Percentages refer to percent by weight unless specifically indicated otherwise.
   I. Manufacture of spray liquors
   I.1 Manufacture of spray liquor 1, SL.1

A stirred tank reactor equipped with mechanical stirrer, pH electrode, temperature element and immersed gas-inlet was charged with 3012 g of (A.1). 1052 g of deionized water were added. Next, gaseous CO₂ (97.2 g, 2.2 mol) was passed through the solution at a rate of approximately 100 g/h at ambient pressure under stirring. A slight temperature increase was observed during CO₂ addition. The carbonized solution SL.1 so obtained had an iron binding capacity of 31.1% and a solids content of 33.1%. The weight increase corresponded to a 3.2% uptake of CO₂ with respect to (A.1).

I.2 Manufacture of spray liquor 2, SL.2

A stirred tank reactor equipped with mechanical stirrer, pH electrode, temperature element and immersed gas-inlet was charged with 3000 g of (A.1). Next, gaseous CO₂ (9.72 g, 0.22 mol) was passed through the solution during a time of 15 minutes at ambient pressure under stirring. The carbonized solution SL.2 so obtained had an iron binding capacity of 40.4% and a solids content of 43.0%. The weight increase corresponded to a 0.3% uptake of CO₂ with respect to (A.1).

### 1.3 Manufacture of Spray Liquor 3, SL.3

Example 1.2 was repeated but only 3.8 g (0.09 mol) gaseous CO₂ were passed through the solution. The carbonized solution SL.3 so obtained had an iron binding capacity of 40.4% and a solids content of 42.9%. The weight increase corresponded to a 0.1% uptake of CO₂ with respect to (A.1).

### II. Spray Granulation

### II.1 Spray Granulation of Spray Liquor SL.1

A laboratory spray granulator, “WFP Mini” commercially available from DMR, was used for the spray granulation experiments. It was charged with 200 g of solid MGDA-Na₃ spherical particles, diameter 350 μm to 1.0 mm, and 100 g of milled MGDA-Na₃ particles. An amount of 22 Nm³/h of air with a temperature of 150-190° C. was blown from the bottom. A fluidized bed of MGDA-Na₃ particles was obtained. The above liquor SL.1 was introduced by spraying 15 g of SL.1 (22° C.) per hour into the fluidized from the bottom through a three-fluid nozzle, absolute pressure in the nozzle: 1.5 to 2.5 bar. Granules were formed, and the bed temperature, which corresponds to the surface temperature of the solids in the fluidized bed, was 95 to 100° C.

Every 15-20 minutes an aliquot of granule (150 to 250 g) was removed from the vessel and classified by sieving. Three fractions were obtained: coarse particles (diameter>1 mm), value fraction (diameter from 350 μm to 1 mm) and fines (diameter<350 μm). The coarse particles, were milled down using a hammer mill (Kinematica Polymix PX-MFL 90D) at 4000 rpm (rounds per minute), 2 mm mesh. The powder so obtained and the fines were returned into the fluidized bed. The value fraction, which was not milled down, left the process and was collected.

After having sprayed 2 kg of SL.1, a steady state was reached. Then, the value fraction was collected as inventive granules.

In the above example, hot air can be replaced by hot nitrogen having the same temperature.

### II.2 Further Experiments

Spray liquors SL.2 to SL.3 and the comparative spray liquor C-SL.4 were treated accordingly.

The inventive granules each contained Na₂CO₃, homogeneously distributed/uniformly dispersed within the particles of the granule.

The properties of the products obtained from the above examples and the comparative example are summarized in Table 2.

TABLE 2
Properties of inventive and comparative granules

| Starting | Lumps | Value fraction | Fines |
|---|---|---|---|
| Material | [Gew.-%] | [Gew.-%] | [Gew.-%] |
| SL. 1 | 3 | 30 | 67 |
| SL. 2 | 43 | 33 | 24 |
| SL. 3 | 37 | 33 | 30 |
| C-SL. 4 | 58 | 32 | 9 |

It can be seen that the share of lumps is drastically reduced by the inventive process. The granules obtained from the inventive process showed excellent storage stability and low yellowing.

1. A process for making a granule comprising an alkali metal salt of an aminocarboxylate complexing agent (A), said process comprising the steps of
(a) providing an aqueous slurry or solution comprising an alkali metal salt of an aminocarboxylate complexing agent (A),
(b) treating said slurry or solution with carbon dioxide, and
(c) removing most of the water by evaporation.

2. The process according to claim 1, wherein step (b) is performed by passing a stream of CO₂ through said solution or slurry.

3. The process according to claim 1, wherein step (c) is performed in a fluidized bed or in a spouted bed or in an essentially horizontal cylindrical drying apparatus comprising a stirring element that rotates around an essentially horizontal axis.

4. The process according to claim 1, wherein step (b) is performed at a temperature in the range of from 10 to 90° C.

5. The process according to claim 1, wherein step (b) is performed at a pressure in the range of from ambient pressure up to 10 bar.

6. The process according to claim 1, wherein the granule or powder of said aminocarboxylate complexing agent (A) in step (a) is a granule or powder from compounds according to general formula (I) 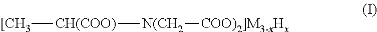
wherein
M is selected from alkali metal cations, same or different, and
x is in the range of from zero to 0.30.

7. The process according to claim 1, wherein the granule or powder of said aminocarboxylate complexing agent (A) in step (a) is a trialkali metal salt of methylglycine diacetic acid (MGDA).

8. The process according to claim 1, wherein the pH value of the solution or slurry at the end of step (b) is in the range of from 9 to 11.

9. A granule or powder of an alkali metal salt (A) of an aminocarboxylate complexing agent wherein said granule or powder contains in the range of from 0.1 to 10% by weight alkali metal carbonate.

10. The granule or powder according to claim 9, wherein the alkali metal salt (A) of an aminocarboxylate complexing agent is selected from compounds according to general formula (I a) 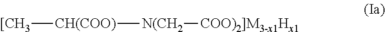
wherein
M is selected from alkali metal cations, same or different, and
x1 is in the range of from zero to 1.2.

11. The granule according to claim 9, wherein said granule has an average particle diameter d50 in the range of from 150 μm to 1.5 mm.

12. The powder according to claim 9, wherein said granule has an average particle diameter d50 in the range of from 30 μm to 125 μm.

13. The granule or powder according to claim 9, wherein the alkali metal carbonate is uniformly dispersed within the particles of the granule or powder.

14. A method for the manufacture of a cleaning agent comprising mixing a powder or granule according to claim 9 with at least one non-ionic surfactant.

15. A solid automatic dishwashing composition comprising a granule according to claim 9.

16. The method of claim 14, further comprising mixing one or more enzymes.

17. The solid automatic dishwashing composition of claim 15, further comprising one or more enzymes.
